(19) United States
(12) Patent Application Publication
(10) Pub. No.: US 2013/0332226 A1
(43) Pub. Date: Dec. 12, 2013

(54) SYSTEM CONTAINING AN INTEGRATION OF COST SAVINGS TRACKER AND SPEND ANALYZER FOR CALCULATING ACTUAL EFFECTIVE SAVINGS

(71) Applicants: PRASAD NAIR, MUMBAI (IN); BIKASH MOHANTY, MUMBAI (IN)

(72) Inventors: PRASAD NAIR, MUMBAI (IN); BIKASH MOHANTY, MUMBAI (IN)

(21) Appl. No.: 13/607,713

(22) Filed: Sep. 8, 2012

(30) Foreign Application Priority Data
Jun. 7, 2012 (IN) 1669/MUM/2012

(51) Int. Cl. G06Q 10/00; G06Q 40/00; G06Q 30/02

(52) U.S. Cl. 705/7.29

(57) ABSTRACT

A system containing an integration of cost savings tracker and spend analyzer for calculating actual effective savings of a spend category in a procurement cycle; the system comprises cost savings tracker module and spend analyzer module; cost savings tracker module of the present system facilitates computation of actual effective cost savings of a spend category and thus facilitates tracking of cost savings of a spend category while Cost Component Model of the spend analyzer module of the present system is meant for spend analysis which facilitates analysis of the procurement cost in relation to market indices of the underlying commodities.

### CROSS-REFERENCE TO RELATED APPLICATION

The instant application claims priority to Indian Patent Application Ser. No. 1669/MUM/2012, filed Jun. 7, 2012, pending, the entire specification of which is expressly incorporated herein by reference.

### FIELD OF THE INVENTION

This invention relates to the field of information and computation systems. Particularly, this invention relates to the field of information and computation systems in relation to procurement cost savings. Particularly, this invention relates to procurement system and method to facilitate calculation of actual effective savings of a spend category and optimization of procurement cost.

### SUMMARY OF THE INVENTION

The present invention is related to the procurement of goods and services. The present invention provides a system containing an integration of cost savings tracker and spend analyzer, which is meant for calculating actual effective cost savings of a spend category in a procurement cycle.

“Cost Saving” achieved while procuring the goods is an indication of performance/effectiveness of the procurement department of an organization. It is very important for procurement department to keep track of savings across each stage of procurement process till the time of actual purchasing of goods and/or services.

In a traditional way of computing cost saving, cost savings are tracked in the excel sheet and there is no system to capture the savings from multiple sources.

In the present invention, this important task of computing cost savings and tracking of cost savings is done by cost savings tracker module of the system.

While optimization of the procurement costs in the light of market dynamics of underlying commodities is facilitated by spend analyzer module of the present system. Market information of the spend category for which cost savings are to be calculated, is received from the Cost Component Model of the spend analyzer module of the system. This Cost component Model of the spend analyzer module is based on market indices for key spend categories and analyzing customer spend data with it.

An object of the present invention is to provide a system containing an integration of cost savings tracker and spend analyzer to calculate actual effective savings of a spend category in a procurement cycle.

A further object of the present invention is to provide a system containing an integration of cost savings tracker and spend analyzer to determine market trend of a spend category based on Cost Component Model of spend analyzer module.

The present invention is related to a system containing an integration of cost savings tracker and spend analyzer for calculating actual effective savings of a spend category in a procurement cycle. In the present invention, the cost savings tracker module of the system is meant for calculating different types of savings of a spend category done by the procurement department in a procurement cycle, based upon the baseline cost information, the purchase cost information of the spend category and receiving average price change market information of that spend category. This market information of a spend category is received from the Cost Component Model of the spend analyzer module of the system associating indication of the plurality of the components for the cost saving which are computed for the spend category with the average price change market information of that spend category derived from the cost component model of spend analyzer; outputting an analysis of effective savings of that spend category based upon pre configured formula.

Cost savings tracker module of the present system facilitates computation of actual effective cost savings of a spend category and thus facilitates tracking of cost savings of a spend category.

Cost Component Model of the spend analyzer module of the present system is meant for spend analysis which facilitates analysis of the procurement cost in relation to market indices of the underlying commodities.

### BRIEF DESCRIPTION OF THE DRAWINGS

The invention will now be described in relation to the accompanying drawings in which:

FIG. 1 illustrates the data flow in the general procurement cycle;

FIG. 2 illustrates a schematic of Cost Savings Tracker Module and Spend Analyzer Module of the present System for calculating actual effective cost savings of a spend category in the procurement cycle; and

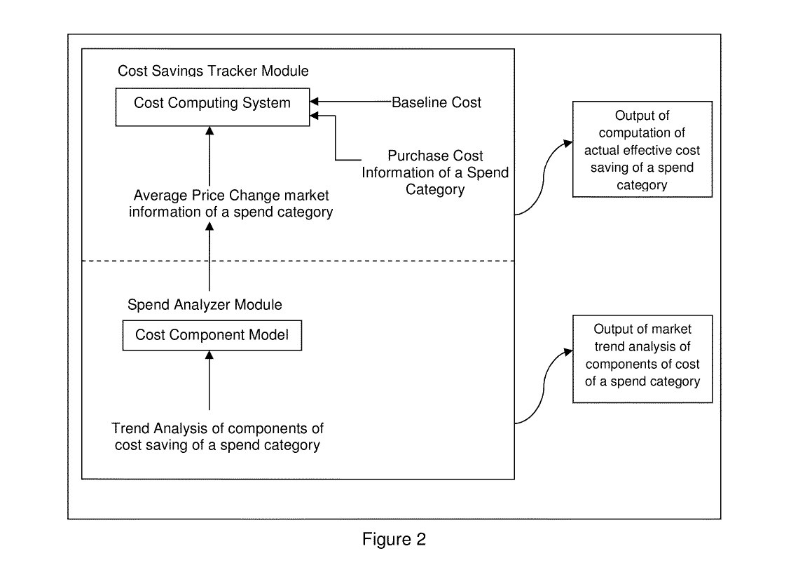

FIG. 3 illustrates Cost Component Model for Ball Bearings.

### DETAILED DESCRIPTION OF THE INVENTION

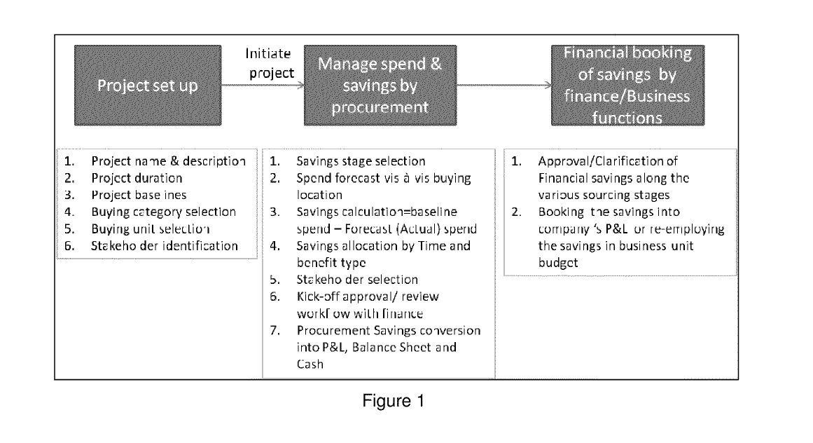

FIG. 1 illustrates data flow of procurement process in the cost savings tracker module of the present system. As shown in FIG. 1, at the initial stages of new project, procurement professionals forecast the procurement cost savings of the new project. These procurement cost savings are generally determined as (Baseline Spend—New Spend). This Baseline Spend is a reference spend, which is defined by the buyer and it is the average of last “n” months of price of that spend category defined by commodity index. Cost savings tracker module of the present system provides this information of the spend category to the user from its spend analysis, if baseline spend is calculated using historical data. Whereas, if the baseline spend is determined by commodity index, spend analyzer module of the present invention provides commodity related information.

In one of the embodiment of the present invention, cost savings tracker module of the system facilitate tracking of cost savings based on its different components in the procurement cycle i.e. ‘benefit type component’, ‘impact type component’, etc. It also facilitates to find out the component of cost saving which has impact on balance sheet and thus indication of performance of procurement department. It also facilitates to find out the component of cost saving which is indication of effective negotiation with the supplier.

In another embodiment of the present invention, market information of the spend category for which cost savings are to be calculated, is received from the Cost Component Model of the spend analyzer module of the system. This Cost Component Model of the spend analyzer module is meant for spend analysis which facilitates analysis of the procurement cost in relation to market indices of the underlying commodities. Cost component model for a spend category provides relative significance of cost drivers based on these market indices. This in turn enables the purchasing professionals to take actions to optimize spend.

In still another embodiment of the present invention, pre-configured Cost Component Models are provided. The user is allowed to select the Cost Component Model from these which is appropriate for the spend category of interest. In this embodiment, the user can also modify the selected pre-configured cost model to better suit the spend category. In an alternative embodiment, the user can formulate the cost component model for the spend category by way of selecting individual cost contributors and assigning weightages to them.

### EXAMPLE 1

| | | | | | Savings due to |
|---|---|---|---|---|---|
| | Unit | | Total | | effective negotiation |
| | price | Quantity | cost | Savings | (Qty constant) |
| Year 2010 | 40 | 20 | 800 | 200 | 200 |
| Year 2011 | 30 | 20 | 600 | | |

In the above example, Baseline Spend (800) is taken from historical database and after deducting actual spends for the year 2011, savings of 200 is arrived. To know whether this negotiated saving is actual effective saving or not, spend analyzer is integrated with cost savings tracker and thus the trend of market price for this commodity compared to the price of that commodity in the year 2010 can be determined.

Suppose that in the year 2011, the price trend is decreased by 10% from the last year's price. So the Baseline Price would be 720 instead of 800 and actual effective saving would be 120 instead of 200.

This actual effective saving is calculated by the formula—B+(% C*B)−P

E.g., 800+(−10% of 800)−600=120

### EXAMPLE 2

Let's take an example of Cost Component Model for Ball bearings.

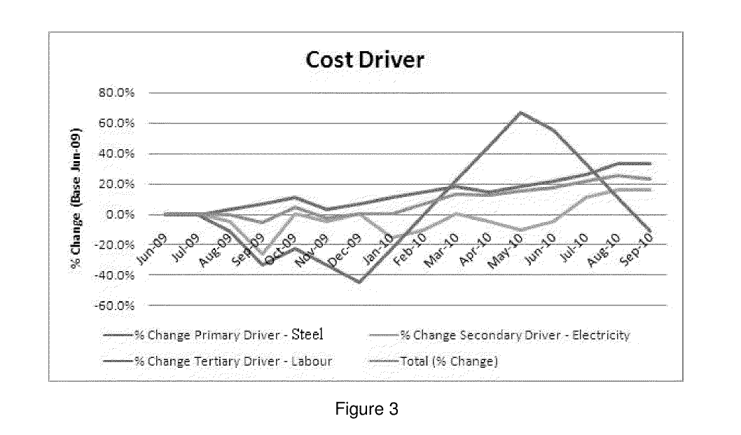

The cost contributors are Stainless Steel, Labor and Electricity and if their significance of contribution to the cost is 40%, 16% and 10%, respectively, the trend of individual cost component as well as cumulative trend, based on relative changes of contributing cost driver for one time period is shown in FIG. 3.

What is claimed is:

1. A system containing an integration of cost savings tracker and spend analyzer for calculating actual effective savings of a spend category in the procurement cycle, comprising:
a cost savings tracker module including a cost saving computing system adapted for computing the plurality of the components for the cost saving for the spend category;
a Cost Component Model of a spend analyzer module adapted for receiving average price change market information of the spend category; and
a system for outputting an analysis of effective savings of that spend category based upon a pre-configured formula.

2. The system as claimed in claim 1, wherein the plurality of the components for cost saving include at least one benefit type component and at least one impact type component.

3. The system as claimed in claim 1, wherein the Cost Component Model of spend analyzer module associated with the indication of the plurality of the components for cost savings which are computed for the spend category with the average price change market information of the cost drivers of that spend category derived from Cost Component Model of spend analyzer module.

4. The system as claimed in claim 1, wherein the Cost Component Model of the spend analyzer module for a spend category provides relative significance of cost drivers based on market indices; the spend analyzer module tracks the top three cost drivers of a spend category.

5. The system as claimed in claim 1, wherein the cost saving computing system of the cost savings tracker module calculates the actual effective savings by the formula:
B+(% C*B)−P
where,
B=baseline cost of a spend category;
% C=% price change of the cost drivers of the spend category from the market information; and
P=purchase cost of a spend category.

6. The system as claimed in claim 1, wherein the Baseline cost of a spend category is determined from Information Provider Module or entered manually by the user.

7. The system as claimed in claim 5, wherein the % price change of the cost drivers of spend category from the market information is received from the Cost Component Model of the spend analyzer module.

8. The system as claimed in claim 1, wherein the Cost Component Model of the spend analyzer module meant to show the market trend for the cost drivers for the Spend category.

9. The system as claimed in claim 8, wherein the Cost Component Model of the spend analyzer module further meant to show the market trend of cost drivers for both direct and indirect spend categories.

10. The system as claimed in claim 1, wherein the Cost Component Model of the spend analyzer module meant to show the trend of individual cost driver of a spend category.

11. The system as claimed in claim 1, wherein the Cost Component Model of the spend analyzer module meant to calculate cumulative trend of cost drivers based on relative changes of contributing cost drivers for a specified time period.

12. The system as claimed in claim 1, wherein the Cost Component Model of the spend analyzer module meant to show the affect of individual cost driver on the cumulative market trend of a spend category.

13. The system as claimed in claim 1, wherein the system provides flexibility to user such that allowing the user to tweak/modify the already available cost models and also further allowing the user to create new cost model.

14. A method for calculating actual effective savings in the procurement cycle, comprising the steps of:
computing the plurality of the components for the cost saving for the spend category
receiving average price change market information of that spend category from the Cost Component Model of the spend analyzer module; and
outputting an analysis of effective savings of that spend category based upon pre-configured formula.

15. The method for calculating actual effective savings in the procurement cycle as claimed in claim 14, wherein the plurality of the components for cost saving include at least one benefit type component and at least one impact type component.

16. The method for calculating actual effective savings in the procurement cycle as claimed in claim 14, wherein the method involved in the Cost Component Model of the spend analyzer module associated with the indication of the plurality of the components for cost savings which are computed for the spend category with the average price change market information of the cost drivers of that spend category derived from Cost Component Model of spend analyzer module.

17. The method for calculating actual effective savings in the procurement cycle as claimed in claim 14, wherein the method involved in the Cost Component Model of the spend analyzer module for a spend category provides relative significance of cost drivers based on market indices; and method for tracking the top three cost drivers of a spend category.

18. The method for calculating actual effective savings in the procurement cycle as claimed in claim 14, wherein the method comprises calculating the actual effective savings by the formula:
B+(% C*B)−P
where,
B=baseline cost of a spend category;
% C=% price change of the cost drivers of the spend category from the market information; and
P=purchase cost of a spend category.

19. The method for calculating actual effective savings in the procurement cycle as claimed in claim 14, wherein the method involves determining the cost of a spend category from Information Provider Module or entering manually by the user.

20. The method for calculating actual effective savings in the procurement cycle as claimed in claim 18, wherein the method involves receiving the value of the % price change of the cost drivers of spend category from the market information from the Cost Component Model of the spend analyzer module.

21. The method for calculating actual effective savings in the procurement cycle as claimed in claim 14, wherein the method involved in the Cost Component Model of the spend analyzer module meant to show the market trend for the cost drivers for Spend category.

22. The method for calculating actual effective savings in the procurement cycle as claimed in claim 21, wherein the method involved in the Cost Component Model of the spend analyzer module meant to show the market trend of the cost drivers for both direct and indirect categories.

23. The method for calculating actual effective savings in the procurement cycle as claimed in claim 14, wherein the method involved in the Cost Component Model of the spend analyzer module meant to show the trend of individual cost drivers of a spend category.

24. The method for calculating actual effective savings in the procurement cycle as claimed in claim 14, wherein the method involved in the Cost Component Model of the spend analyzer module meant to calculate cumulative trend of cost drivers based on relative changes of contributing cost drivers for a specified time period.

25. The method for calculating actual effective savings in the procurement cycle as claimed in claim 14, wherein the method involved in the Cost Component Model of the spend analyzer module meant to show the affect of individual cost drivers on the cumulative market trend of a spend category.

26. The method for calculating actual effective savings in the procurement cycle as claimed in claim 14, wherein the method meant to provide flexibility to user such that allowing the user to tweak/modify the already available cost models and also further allowing the user to create new cost model.
